(19) United States
(12) Patent Application Publication
(10) Pub. No.: US 2024/0075992 A1
(43) Pub. Date: Mar. 7, 2024

(54) Stake Pocket Insert For Accessory Attachment

(71) Applicant: Dirtcom Inc., Montclair, CA (US)

(72) Inventors: Allan Joseph Ayson Liwanag, Upland, CA (US); Mitchell Molina, Rancho Cucamonga, CA (US)

(73) Assignee: Dirtcom, Inc., Montclair, CA (US)

(21) Appl. No.: 18/460,542

(22) Filed: Sep. 2, 2023

Related U.S. Application Data
(60) Provisional application No. 63/374,541, filed on Sep. 3, 2022.

(51) Int. Cl. B62D 33/02

(52) U.S. Cl. CPC B62D 33/0207

(57) ABSTRACT

A stake pocket insert for attaching a vehicle accessory to a vehicle. The stake pocket insert may comprise a member configured to be disposed within a stake pocket of the vehicle and facilitate attachment of the vehicle accessory to the vehicle. The member may include a first surface, a second surface, and a bore extending through the member between the first surface and the second surface. The bore may include a smooth bore portion having a smooth inner surface, wherein the smooth bore portion is configured to accommodate a vehicle accessory having a smooth outer surface. The bore may also include a threaded bore portion having a threaded inner surface, wherein the threaded bore portion is configured to accommodate a vehicle accessory having a threaded outer surface.

### CROSS-REFERENCE TO RELATED APPLICATIONS

This application claims priority to and the benefit of U.S. Provisional Patent Application No. 63/374,541, entitled “STAKE POCKET INSERT FOR ACCESSORY ATTACHMENT,” filed Sep. 3, 2022, the entire disclosure of which is hereby incorporated herein by reference.

### BACKGROUND OF THE DISCLOSURE

Sidewalls of a truck bed often include one or more stake pockets, which provide access to enclosed areas within the sidewalls of the truck bed. Stake pockets allow a truck user to attach various vehicle accessories, such as tie-downs, rails, and racks to the sidewall of the truck bed. Various stake pocket inserts for connecting accessories within the stake pockets are known in the art. However, such known stake pocket inserts are complicated, comprising many separable components. A common problem with such known stake pocket inserts is that oftentimes one or more components will get lost, rendering the stake pocket insert inoperable. Furthermore, many of the known stake pocket inserts lack the means to reliably secure a vehicle accessory to the truck bed sidewall, allowing the vehicle accessory to disengage from the truck bed stake pockets while the truck is in motion, thereby rendering such stake pocket inserts unsafe for transportation. Furthermore, many known stake pocket inserts extend out of the stake pockets when not in use, causing such stake pocket inserts to get in the way, prevent full use of the truck bed, and/or cause injury. Also, many known stake pocket inserts are configured to connect only one type of vehicle accessory within the stake pockets, thereby requiring changing of the stake pocket inserts when different vehicle accessories are used.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic view of at least a portion of an example implementation of apparatus according to one or more aspects of the present disclosure.

FIG. 2 is an exploded perspective view of at least a portion of an example implementation of apparatus according to one or more aspects of the present disclosure.

FIG. 3 is a perspective view of a portion of the apparatus shown in FIG. 2.

FIG. 4 is an axial view of the apparatus shown in FIG. 3.

FIG. 5 is a side view of the apparatus shown in FIGS. 3 and 4.

FIG. 6 is a front view of the apparatus shown in FIGS. 3-5.

FIG. 7 is a back view of the apparatus shown in FIGS. 3-6.

FIG. 8 is a side sectional view of the apparatus shown in FIGS. 2-7 in an example operational configuration according to one or more aspects of the present disclosure.

FIG. 9 is a side sectional view of the apparatus shown in FIG. 8 in another example operational configuration according to one or more aspects of the present disclosure.

FIG. 10 is a side sectional view of the apparatus shown in FIGS. 8 and 9 in another example operational configuration according to one or more aspects of the present disclosure.

FIG. 11 is a side sectional view of the apparatus shown in FIGS. 8-10 in another example operational configuration according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for simplicity and clarity, and does not in itself dictate a relationship between the various embodiments and/or configurations discussed. Moreover, the formation of a first feature over or on a second feature in the description that follows, may include embodiments in which the first and second features are formed in direct contact, and may also include embodiments in which additional features may be formed interposing the first and second features, such that the first and second features may not be in direct contact.

Furthermore, terms, such as upper, upward, above, lower, downward, and/or below are utilized herein to indicate relative positions and/or directions between apparatuses, tools, components, parts, portions, members and/or other elements described herein, as shown in the corresponding figures. Such terms do not necessarily indicate relative positions and/or directions when actually implemented. Such terms, however, may indicate relative positions and/or directions with respect to the ground (i.e., the Earth's surface).

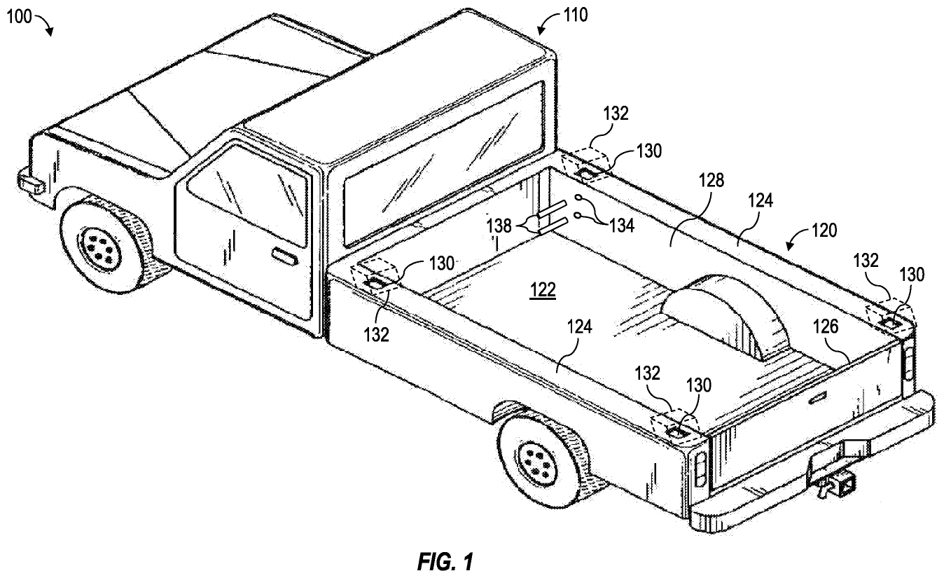

FIG. 1 is a schematic view of an example implementation of a vehicle 100 representing an example environment in which one or more aspects of the present disclosure may be implemented. The vehicle 100 is a pickup truck having a cab section 110 and a bed section 120. The bed section 120 comprises a bed 122 and sidewalls 124 on opposing sides of the bed 122. The bed section 120 may further comprise a tailgate 126 between the sidewalls 124 at the end of the bed 122 opposite the cab section 110. The bed section 120 comprises a plurality of stake pockets 130 (e.g., holes, cavities, receptacles, etc.) extending into an internal space of each sidewall 124. Although not shown, other stake pockets 130 may also extend into an internal space of the tailgate 126. The stake pockets 130 are configured to receive and facilitate mounting (or attachment) of various vehicle accessories 132 to the sidewalls 124. For example, the stake pockets 130 may receive tie-down anchors or legs (not shown) of the vehicle accessories 132 to connect the vehicle accessories 132 to the sidewalls 124. One or more bores 134 may extend into and through a side surface 128 of each sidewall 124 to a corresponding stake pocket 130. Fasteners 138 (e.g., bolts, pins, etc.) may be inserted through the bores 134 and engage a tie-down anchor, leg, or other portion of a vehicle accessory 132 disposed within the stake pockets 130 to maintain the vehicle accessory 132 within the stake pockets 130 and thereby connect (e.g., mount or attach) the vehicle accessory 132 to the sidewalls 124. Although each sidewall 124 is shown comprising two bores 134, each extending through the side surfaces 128 for each stake pocket 130, the sidewalls 124 may include a different number of bores 134 associated with each stake pocket 130.

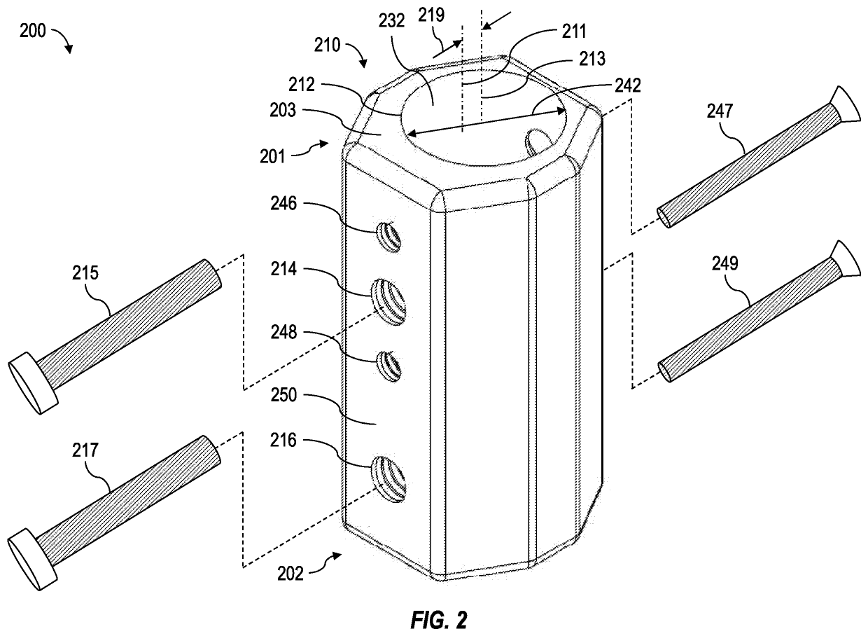

FIGS. 2-7 are views of an example implementation of an assembly (or device) 200 according to one or more aspects of the present disclosure for facilitating detachable connection (e.g., mounting, attachment, etc.) of an object, such as the vehicle accessory 132 shown in FIG. 1, to a vehicle, such as the vehicle 100 shown in FIG. 1. The assembly 200 comprises an insert body (or member) 210 configured to be inserted or otherwise disposed within a stake pocket 130 of the vehicle 100. The body 210 may be configured to accommodate therein and connect with a portion of the vehicle accessory 132. The body 210 may be further configured to be disposed within the stake pocket 130, detachably connected to the sidewall 124 of the vehicle while the body 210 is disposed within the stake pocket 130 and, thus, connect (e.g., mount, attach, etc.) or otherwise facilitate attachment of the vehicle accessory 132 to the vehicle 100.

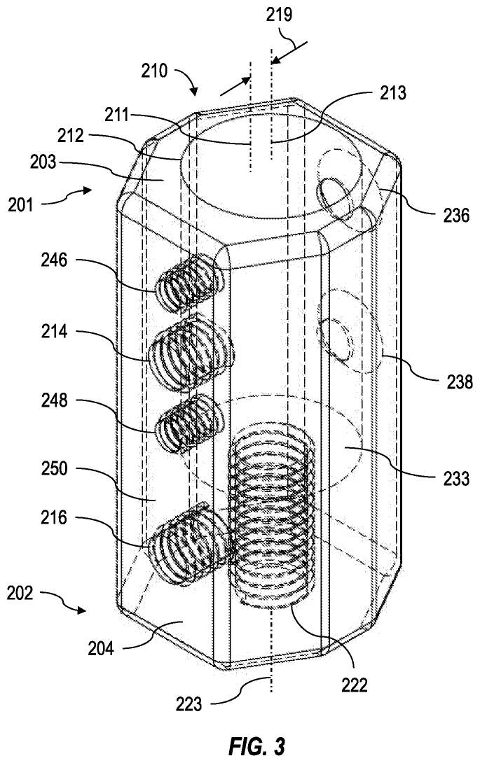

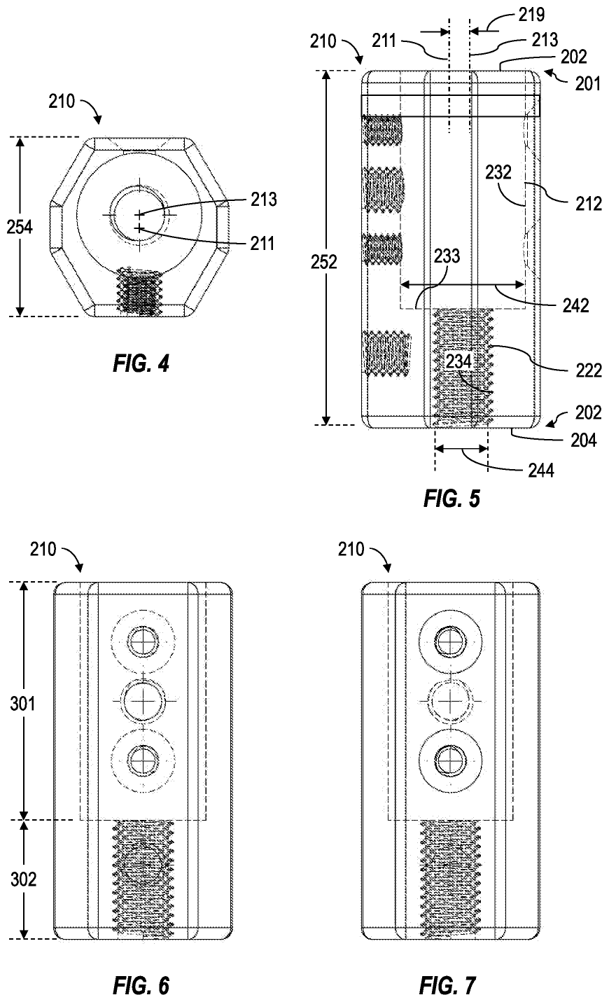

FIG. 2 is an exploded perspective view of the assembly 200 without showing hidden lines, whereas FIG. 3 is a perspective view of the body 210 of the assembly 200 showing hidden lines indicative of internal configuration of the body 210. FIGS. 4-7 are respective axial, side, front, and back views of the body 210 showing hidden lines. The following description of FIGS. 2-7 is presented in the example context of the vehicle 100 shown in FIG. 1 (although the assembly 200 may be utilized with vehicles other than the vehicle 100 shown in FIG. 1). Accordingly, the following description refers to FIGS. 1-7, collectively.

In addition to the body 210, which is configured to be inserted into or otherwise disposed within the stake pocket 130, the assembly 200 also comprises one or more fasteners 215, 217 for detachably connecting the body 210 to the sidewall 124 when the body 210 is disposed within the stake pocket 130, as described below. The body 210 may be or comprise an insertable mount, bracket, or another member for facilitating mounting of the vehicle accessory 132 to the vehicle 100.

The body 210 may comprise a vehicle accessory receiving bore 212 extending longitudinally through a portion 301 of the body 210. The bore 212 may be configured to receive (or accommodate) a portion of the vehicle accessory 132 and retain that portion therein to thereby connect the vehicle accessory 132 to the vehicle 100. The body 210 may further comprise another vehicle accessory receiving bore 222 extending longitudinally through a portion 302 of the body 210. The bore 222 may be configured to receive (or accommodate) a portion of a different vehicle accessory 132 and retain that portion of the different vehicle accessory 132 therein to thereby connect the different vehicle accessory 132 to the vehicle 100. An outer opening of the bore 212 may be located on one end 201 of the body 210, and an outer opening of the bore 222 may be located on the opposite end 202 of the body 210. The bores 212, 222 may be coaxial, such that central axes 213, 223 of the respective bores 212, 222 may coincide. The body 210 may comprise a surface 203 defining the end 201 of the body 210 and a surface 204 defining the end 202 of the body 210. The bore 212 may extend from the surface 202 and the bore 222 may extend from the surface 204.

The bores 212, 222 may comprise different geometries (e.g., inner diameter, depth, etc.). For example, an inner diameter 242 of the bore 212 may be larger than an inner diameter 244 of the bore 222. Thus, the bore 212 may be configured to receive (or accommodate) a larger accessory than the bore 222. The diameter 242 of the bore 212 may range between 0.5-1.5 inches (1.2-3.9 centimeters (cm)), between 0.75-1.25 inches (1.9-3.2 cm), or other ranges. In example implementations, the diameter 242 of the bore 212 may be 0.75 inches (1.9 cm), 1.0 inches (2.5 cm), or 1.25 inches (3.2 cm).

The bore 212 may have (or be defined by) a smooth inner (or side) surface 232 (i.e., inner surface of the body 212 defining the bore 212) configured to receive or otherwise accommodate a portion of the vehicle accessory 132 having a cylindrical geometry with a smooth outer surface. However, the bore 212 may be configured to receive or otherwise accommodate a portion of the vehicle accessory having a different geometry, such as square, hexagonal, or octagonal cross-sectional shape, among other examples. An example of such vehicle accessories may include a flagpole.

The bore 222 may have (or be defined by) a threaded inner (or side) surface 234 (i.e., inner surface of the body 212 defining the bore 222) configured to receive or otherwise accommodate a portion of the vehicle accessory 132 having a cylindrical geometry with a threaded outer surface (i.e., male threads). The bore 222 may, thus, receive and threadedly engage with a portion of the vehicle accessory 132 having corresponding male threads to thereby connect the vehicle accessory 132 to the body 210 and, thus, the vehicle 100. In an example implementation, the bore 222 may comprise female threads having a half inch nominal diameter and 13 threads per inch (i.e., ½-13 thread pitch). Examples of such vehicle accessories 132 may include an antenna having a threaded base, a whip having a threaded base, and an anchor bolt or another bolt having male threads.

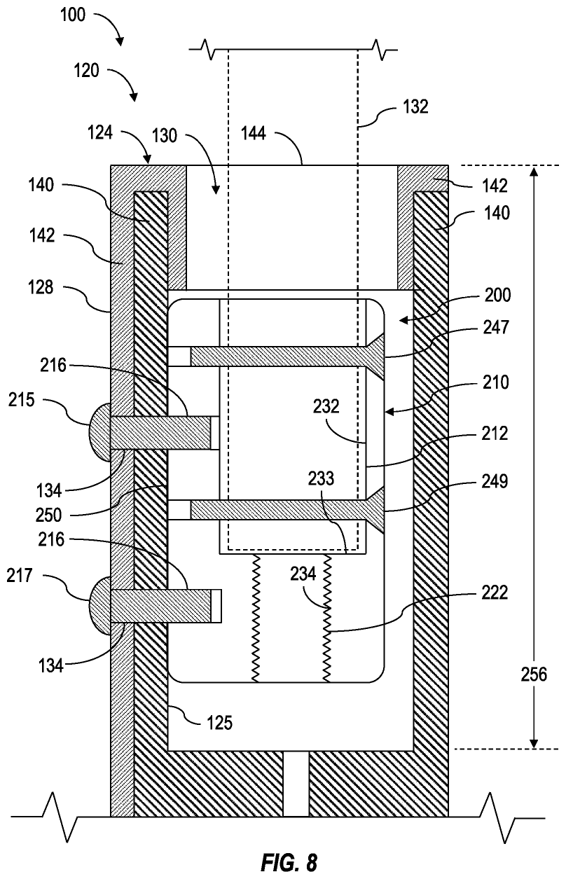

The bores 212, 222 may be located or extend eccentrically through the body 210. For example, the bores 212, 222 may have a common centerline (i.e., concentric central axes 213, 223) and the body 212 may have a centerline 211, wherein the centerline 213, 223 and the centerline 211 are parallel with respect to each other and offset from each other by a distance 219. The centerline 211 of the body 210 may be or comprise a geometric centerline (or an axis of symmetry) of the body 210 extending along the center of an axial profile of the body 210. Accordingly, when the body 210 is disposed within the stake pocket 130 and connected to an inner side surface 125 (as shown in FIG. 8) of the sidewall 124 of the vehicle 100 defining the stake pocket 130, the bores 212, 222 are spaced away (or offset) from the inner side surface 125 of the sidewall 124 defining the stake pocket 130 such that the bores 212, 222 are aligned with or otherwise positioned below an opening 144 (as shown in FIG. 8) of the stake pocket 130 and, thus, prevent or inhibit the vehicle accessory 132 from contacting the inner side surface 125 or other portions of the sidewall 124 of the vehicle 100.

The bores 212, 222 may be connected, and thus comprise a single continuous bore 212, 222 having two bore portions. For example, the bore 212, 222 may comprise a bore portion 212 extending into one end 201 of the body 210 and having specifications (or parameters) of the bore 212 described herein. Similarly, the bore 212, 222 may comprise a bore portion 222 extending into the opposite end 202 of the body 210 and having specifications (or parameters) of the bore 222 described herein. The bore portion 212 may extend from the surface 202 and the bore portion 222 may extend from the surface 204. The bore 212, 222 may extend continuously through the body 210 between the surface 202 and the surface 204. The bore 212, 222 may further comprise an annular transition surface (or shoulder) 233 extending (or transitioning) between the inner surface 232 and the inner surface 234. The surface 233 is configured to contact and maintain axial position of an end of a vehicle accessory 132 (e.g., such as having a smooth outer surface) when the vehicle accessory 132 is disposed within the bore portion 232 (as shown in FIG. 8).

The body 210 may further comprise a vehicle accessory connection bore 246 extending laterally (e.g., perpendicularly) through the body 210 and with respect to the bore 212. The bore 246 and the bore 212 may intersect. The bore 246 may be configured to receive or otherwise accommodate a fastener 247 such that the fastener 247 extends through the bore 212 and a bore of the vehicle accessory 132 when the vehicle accessory 132 is disposed within the bore 212 to detachably connect the vehicle accessory 132 to the body 210 and, thus, the vehicle 100. The body 210 may also comprise another vehicle accessory connection bore 248 extending laterally (e.g., perpendicularly) through the body 210 and with respect to the bore 212. The bore 248 and the bore 212 may intersect. The bore 248 may be configured to receive or otherwise accommodate a fastener 249 such that the fastener 249 extends through the bore 212 and a bore of the vehicle accessory 132 when the vehicle accessory 132 is disposed within the bore 212 to detachably connect the vehicle accessory 132 to the body 210 and, thus, the vehicle 100. Each bore 246, 248 may comprise female threads (i.e., a threaded inner surface) and each fastener 247, 249 may comprise male threads (i.e., a threaded outer surface) configured to threadedly engage the female threads of the bores 246, 248. Each of the bores 246, 248 may comprise a countersunk portion 236, 238 for receiving a head of each fastener 247, 249, such as to reduce overall width of the body 210 and the fasteners 247, 249 and thereby permit the body 210 and the fasteners 247, 249 to be inserted into the stake pocket 130.

The body 210 may further comprise a vehicle connection bore 214 extending laterally (e.g., perpendicularly) through the body 210 and with respect to the bores 212, 222. The bore 214 may be configured to receive the fastener 215 for detachably connecting the body 210 to the sidewall 124 of the vehicle 100 when the body 210 is disposed within the stake pocket 130. The body 210 may also comprise another vehicle connection bore 216 extending laterally (e.g., perpendicularly) through the body 210 and with respect to the bores 212, 222. The bore 216 may be configured to receive the fastener 217 for detachably connecting the body 210 to the sidewall 124 when the body 210 is disposed within the stake pocket 130. Each bore 214, 216 may comprise female threads (i.e., a threaded inner surface) and each fastener 215, 217 may comprise male threads (i.e., a threaded outer surface) configured to threadedly engage the female threads of the bores 214, 216. For example, one or more of the fasteners 215, 217 may be configured to extend through the bores 134 in the sidewalls 124 of the vehicle 100 and threadedly engage one or more of the bores 214, 216 to detachably connect the body 210 to the sidewall 124 when the body 210 is disposed within the stake pocket 130.

The body 210 may further comprise a mounting surface 250 configured to contact an inner surface of the stake pocket 130 when the body 210 is disposed within the stake pocket 130 such that the body 210 can be detachably connected to the vehicle 100 as described herein. The surface 250 may be located or extend between the surfaces 203, 204. One or more of the bores 246, 248 may extend into and through the mounting surface 250. One or more of the bores 214, 216 may extend into and through the mounting surface 250. Thus, when the body 210 is disposed within the stake pocket 130, the mounting surface 250 may be disposed against the inner surface of the stake pocket 130 such that one or more of the bores 214, 216 is aligned with one or more of the bores 134. One or more of the fasteners 215, 217 may then be inserted through the bores 134 and engage one or more of the bores 214, 216 to detachably connect the body 210 to the sidewall 124. The body 210 may be inserted into the stake pocket 130 and connected to the sidewall 124 such that the bore 212 is facing upward, away from the bed 122, and the vehicle accessory 132 can then be inserted into the bore 212 and connected to the body 210. The body 210 may instead be inserted into the stake pocket 130 and connected to the sidewall 124 such that the bore 222 is facing upward and the vehicle accessory 132 can then be inserted into the bore 222 and connected to the body 210. However, a vehicle accessory 132 may be first inserted into one of the bores 212, 222 and connected to the body 210, then the body 210 may be inserted into the stake pocket 130 and connected to the sidewall 124 of the vehicle 100 to thereby connect the vehicle accessory 130 to the vehicle 100.

The body 210 may have a height (or length) 252 configured to be less than a depth 256 (as shown in FIG. 8) of the stake pocket 130 such that the body 210 is fully encompassed within the stake pocket 130 when the body 210 is disposed within the stake pocket 130 and connected to the sidewall 124. Thus, the height 252 of the body 210 may be configured such that each end surface 203, 204 (and end 201, 202) of the body 210 is located below an opening 144 of the stake pocket 130 when the body 210 is disposed within the stake pocket 130 and connected to the sidewall 124. The height 252 of the body 210 may range between 2-5 inches (5.0-12.7 cm), between 3-4 inches (7.6-10.2 cm), or another range. In example implementations, the height 252 may be 2.5 inches (6.3 cm), 3.0 inches (7.6 cm), 3.5 inches (8.9 cm), or 4.0 inches (10.2 cm). The body 210 may have a width 254 configured such that the body 210 can fit within the stake pocket 130. The width 254 of the body 210 may range between 1.5-3.0 inches (3.8-7.6 cm), between 2.0-2.5 inches (5.1-6.4 cm), or another range. In example implementations, the width 254 may be 1.5 inches (3.8 cm), 1.75 inches (4.4 cm), or 2.0 inches (5.1 cm).

With continued reference to FIG. 1, FIGS. 8-11 are schematic sectional views of the assembly 200 mounted within a stake pocket 130 of the vehicle 100 and connecting various accessories 132 to the vehicle 100. FIGS. 8-11 show the body 210 disposed within the stake pocket 130. The mounting surface 250 is disposed against an inner side surface 125 of a wall of the sidewall 124 that defines the stake pocket 130. The fasteners 215, 217 extend through the bores 134 in the wall of the sidewall 124 and engage the bores 214, 216 of the body 210 thereby detachably connecting the body 210 to the wall of the sidewall 124 of the vehicle 100. Each wall of the sidewall 124 may comprise a steel sheet 140 coated or overlaid by a plastic cover 142. The plastic cover 142 may narrow or otherwise decrease the size of the opening 144 of the stake pocket 130. However, the centerline 213, 223 (as shown in FIGS. 2 and 3) of the bores 212, 222 and the centerline 211 (as shown in FIGS. 2 and 3) of the body 210 may be offset from each other such that the bores 212, 222 are spaced away (or offset) from the inner surface 125 of the wall of the sidewall 124, resulting in the bores 212, 222 being positioned away from the inner surface 125 and below the opening 144 of the stake pocket 130, thereby preventing or inhibiting the vehicle accessory 132 from contacting the inner surface 125 or the plastic cover 142 of the sidewall 124 of the vehicle 100. The following description refers to FIGS. 1-11, collectively.

FIG. 8 shows the body 210 inserted into the stake pocket 130 and connected to the sidewall 124 of the vehicle such that the bore 212 is facing upward, away from the bed 122, and the vehicle accessory 132 (depicted in dashed lines) can be inserted into the bore 212 and connected to the body 210. The vehicle accessory 132 may be connected to the body 210 via the fasteners 249 extending through the body 210, the bore 212, and the vehicle accessory 132. The vehicle accessory 132 may be or comprise a flagpole.

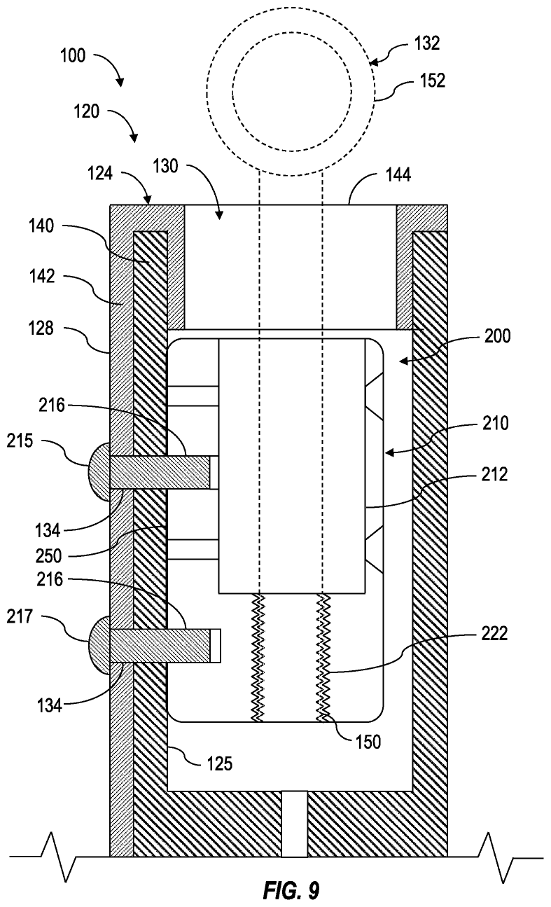

FIG. 9 shows the body 210 inserted into the stake pocket 130 and connected to the sidewall 124 such that the bore 212 is facing upward, away from the bed 122, and the vehicle accessory 132 (depicted in dashed lines) can be inserted into the bore 222 via the bore 212 and connected to the body 210. The vehicle accessory 132 may be connected to the body 210 by engaging male threads 150 of the vehicle accessory 132 with the female threads of the bore 222. The vehicle accessory 132 may be or comprise a tie-down anchor bolt having the male threads 150 and an eye 152, or another vehicle accessory 132 comprising a threaded bolt end.

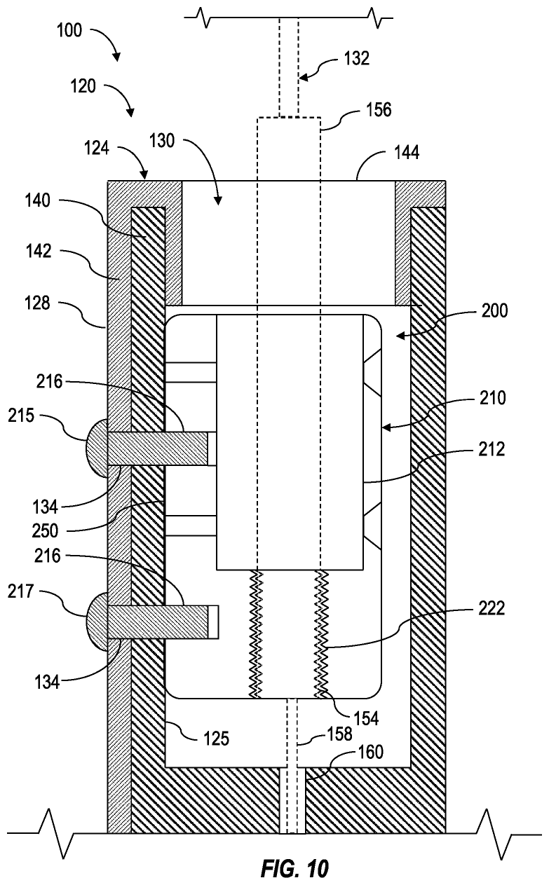

FIG. 10 shows the body 210 inserted into the stake pocket 130 and connected to the sidewall 124 such that the bore 212 is facing upward, away from the bed 122, and the vehicle accessory 132 (depicted in dashed lines) can be inserted into the bore 222 via the bore 212 and connected to the body 210. The vehicle accessory 132 may be connected to the body 210 by engaging male threads 154 of the vehicle accessory 132 with the female threads of the bore 222. The vehicle accessory 132 may be or comprise an antenna or a whip having a long base 156 terminating with the male threads 154. The long base 156 may permit rotation of the male threads 154 of the vehicle accessory 132 to engage the male threads 154 with the female threads of the bore 222. The conductor 158 of the antenna 132 may be directed though a bore 160 extending through the sidewall 124 and connected to a radio communication device (not shown).

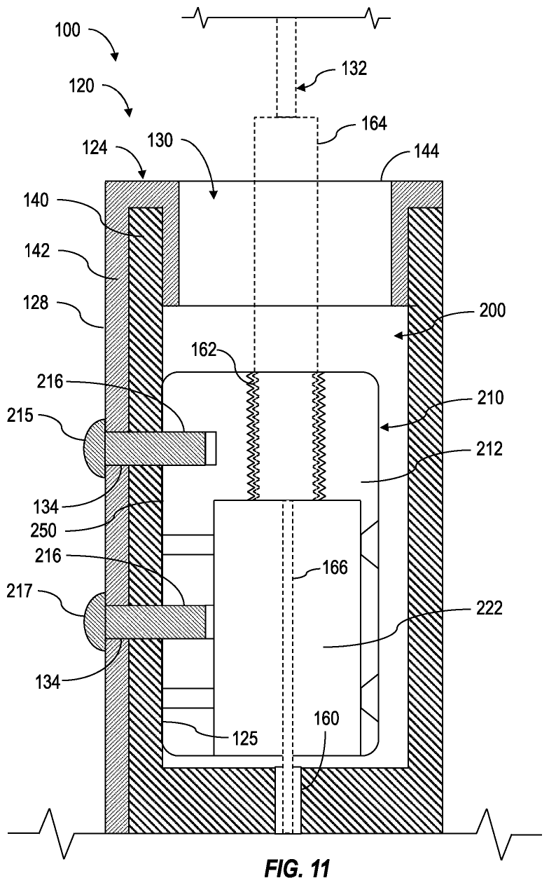

FIG. 11 shows the body 210 inserted into the stake pocket 130 and connected to the sidewall 124 of the vehicle such that the bore 222 is facing upward, away from the bed 122, and the vehicle accessory 132 (depicted in dashed lines) can be inserted directly into the bore 222 and connected to the body 210. The vehicle accessory 132 may be connected to the body 210 by engaging male threads 162 of the vehicle accessory 132 with the female threads of the bore 222. The vehicle accessory 132 may be or comprise an antenna or a whip having a short base 164 terminating with the male threads 162, thereby requiring that the bore 222 be closer to the opening 144 of the stake pocket 130. The base 164 may be rotated to engage the male threads 162 of the vehicle accessory 132 with the female threads of the bore 222. The conductor 166 of the antenna may be directed though the bore 160 extending through the sidewall 124 and connected to the radio communication device (not shown).

In view of the entirety of the present disclosure, a person having ordinary skill in the art will readily recognize that the present disclosure introduces an apparatus comprising: a member configured to be disposed within a stake pocket of a vehicle and facilitate attachment of a vehicle accessory to the vehicle, wherein the member comprises: a first surface; a second surface; and a bore extending through the member between the first surface and the second surface. The bore comprises: a smooth bore portion having a smooth inner surface, wherein the smooth bore portion is configured to accommodate a vehicle accessory having a smooth outer surface; and a threaded bore portion having a threaded inner surface, wherein the threaded bore portion is configured to accommodate a vehicle accessory having a threaded outer surface.

The vehicle accessory may comprise at least one of a flagpole; an antenna; a whip; an anchor bolt; and a threaded bolt.

The bore may further comprise an annular surface extending between the smooth inner surface and the threaded inner surface, and the annular surface may be configured to contact an end of the vehicle accessory having the smooth outer surface when the vehicle accessory having the smooth outer surface is disposed within the smooth bore portion.

The smooth bore portion may have a first inner diameter; the threaded bore portion may have a second inner diameter; the first inner diameter may be larger than the second inner diameter; the bore may further comprise an annular surface extending between the smooth inner surface and the threaded inner surface; and the annular surface may be configured to contact an end of the vehicle accessory having the smooth outer surface when the vehicle accessory having the smooth outer surface is disposed within the smooth bore portion.

The first surface may define a first end of the member; the second surface may define a second end of the member; the smooth bore portion may extend from the first surface; and the threaded bore portion may extend from the second surface.

The first surface may define a first end of the member; the second surface may define a second end of the member; the member may be configured such that the first surface and the second surface are located below an opening of the stake pocket when the member is disposed within the stake pocket; the member may further comprise a third surface between the first surface and the second surface; and the third surface may be configured to contact a surface of the vehicle when the member is disposed within the stake pocket.

The height of the member may be less than a depth of the stake pocket such that the member is fully encompassed within the stake pocket when the member is disposed within the stake pocket.

The member may have a first central axis; the bore may extend along a second central axis; and the first central axis and the second central axis may be parallel and offset from each other.

The present disclosure also introduces an apparatus comprising: a member configured to be disposed within a stake pocket of a vehicle and facilitate attachment of a vehicle accessory to the vehicle. The member comprises: a first surface defining a first end of the member; a second surface defining a second end of the member, wherein the member is configured such that the first surface and the second surface are located below an opening of the stake pocket when the member is disposed within the stake pocket; a third surface between the first surface and the second surface, wherein the third surface is configured to contact a surface of the vehicle when the member is disposed within the stake pocket; a first bore extending through the member from the first surface, wherein the first bore is configured to accommodate the vehicle accessory; and a second bore extending through the member from the third surface, wherein the second bore is configured to accommodate a fastener for detachably connecting the member to the surface of the vehicle when the member is disposed within the stake pocket.

The vehicle accessory may comprise at least one of a flagpole; an antenna; a whip; an anchor bolt; and a threaded bolt.

The first bore may comprise: a smooth bore portion having a smooth inner surface, wherein the smooth bore portion is configured to accommodate a vehicle accessory having a smooth outer surface; and a threaded bore portion having a threaded inner surface, wherein the threaded bore portion is configured to accommodate a vehicle accessory having a threaded outer surface.

The first bore may extend through the member between the first surface and the second surface; the smooth bore portion may extend from the first surface; and the threaded bore portion may extend from the second surface.

The member may further comprise a third bore extending through the member; the third bore may be configured to accommodate a fastener for detachably connecting the vehicle accessory to the member when the vehicle accessory is disposed within the first bore; and the first bore and the third bore may intersect.

The member may have a central axis; the first bore may extend along a central axis; and the central axis of the member and the second central of the bore may be parallel and offset from each other.

The present disclosure also introduces an apparatus comprising: a member configured to be disposed within a stake pocket of a vehicle and facilitate attachment of a vehicle accessory to the vehicle. The member comprises: a first surface defining a first end of the member; a second surface defining a second end of the member, wherein the member is configured such that the first surface and the second surface are located below an opening of the stake pocket when the member is disposed within the stake pocket; a first bore extending through the member from the first surface, wherein the first bore is configured to accommodate the vehicle accessory; and a second bore extending through the member, wherein the second bore is configured to accommodate a fastener for detachably connecting the vehicle accessory to the member when the vehicle accessory is disposed within the first bore, and wherein the first bore and the third bore intersect.

The vehicle accessory may comprise at least one of a flagpole; an antenna; a whip; an anchor bolt; and a threaded bolt.

The member may further comprise: a third surface between the first surface and the second surface, wherein the third surface is configured to contact a surface of the vehicle when the member is disposed within the stake pocket; a third bore extending through the member from the third surface, wherein the third bore is configured to accommodate a fastener for detachably connecting the member to the surface of the vehicle when the member is disposed within the stake pocket.

The first bore may comprise: a smooth bore portion having a smooth inner surface, wherein the smooth bore portion is configured to accommodate a vehicle accessory having a smooth outer surface; and a threaded bore portion having a threaded inner surface, wherein the threaded bore portion is configured to accommodate a vehicle accessory having a threaded outer surface.

The first bore may extend through the member between the first surface and the second surface; the smooth bore portion may extend from the first surface; and the threaded bore portion may extend from the second surface.

The member may have a central axis; the first bore may extend along a central axis; and the central axis of the member and the second central of the bore may be parallel and offset from each other.

The foregoing outlines features of several embodiments so that a person having ordinary skill in the art may better understand the aspects of the present disclosure. A person having ordinary skill in the art should appreciate that they may readily use the present disclosure as a basis for designing or modifying other processes and structures for carrying out the same purposes and/or achieving the same advantages of the embodiments introduced herein. A person having ordinary skill in the art should also realize that such equivalent constructions do not depart from the scope of the present disclosure, and that they may make various changes, substitutions and alterations herein without departing from the scope of the present disclosure.

What is claimed is:

1. An apparatus comprising:
a member configured to be disposed within a stake pocket of a vehicle and facilitate attachment of a vehicle accessory to the vehicle, wherein the member comprises:
a first surface;
a second surface; and
a bore extending through the member between the first surface and the second surface, wherein the bore comprises:
a smooth bore portion having a smooth inner surface, wherein the smooth bore portion is configured to accommodate a vehicle accessory having a smooth outer surface; and
a threaded bore portion having a threaded inner surface, wherein the threaded bore portion is configured to accommodate a vehicle accessory having a threaded outer surface.

2. The apparatus of claim 1 wherein:
the bore further comprises an annular surface extending between the smooth inner surface and the threaded inner surface; and
the annular surface is configured to contact an end of the vehicle accessory having the smooth outer surface when the vehicle accessory having the smooth outer surface is disposed within the smooth bore portion.

3. The apparatus of claim 1 wherein:
the smooth bore portion has a first inner diameter;
the threaded bore portion has a second inner diameter;
the first inner diameter is larger than the second inner diameter;
the bore further comprises an annular surface extending between the smooth inner surface and the threaded inner surface; and
the annular surface is configured to contact an end of the vehicle accessory having the smooth outer surface when the vehicle accessory having the smooth outer surface is disposed within the smooth bore portion.

4. The apparatus of claim 1 wherein:
the first surface defines a first end of the member;
the second surface defines a second end of the member;
the smooth bore portion extends from the first surface; and
the threaded bore portion extends from the second surface.

5. The apparatus of claim 1 wherein:
the first surface defines a first end of the member;
the second surface defines a second end of the member;
the member is configured such that the first surface and the second surface are located below an opening of the stake pocket when the member is disposed within the stake pocket;
the member further comprises a third surface between the first surface and the second surface; and
the third surface is configured to contact a surface of the vehicle when the member is disposed within the stake pocket.

6. The apparatus of claim 1 wherein height of the member is less than a depth of the stake pocket such that the member is fully encompassed within the stake pocket when the member is disposed within the stake pocket.

7. The apparatus of claim 1 wherein:
the member has a first central axis;
the bore extends along a second central axis; and
the first central axis and the second central axis are parallel and offset from each other.

8. The apparatus of claim 1 wherein the vehicle accessory comprises at least one of:
a flagpole;
an antenna;
a whip;
an anchor bolt; and
a threaded bolt.

9. An apparatus comprising:
a member configured to be disposed within a stake pocket of a vehicle and facilitate attachment of a vehicle accessory to the vehicle, wherein the member comprises:
a first surface defining a first end of the member;
a second surface defining a second end of the member, wherein the member is configured such that the first surface and the second surface are located below an opening of the stake pocket when the member is disposed within the stake pocket;
a third surface between the first surface and the second surface, wherein the third surface is configured to contact a surface of the vehicle when the member is disposed within the stake pocket;
a first bore extending through the member from the first surface, wherein the first bore is configured to accommodate the vehicle accessory; and
a second bore extending through the member from the third surface, wherein the second bore is configured to accommodate a fastener for detachably connecting the member to the surface of the vehicle when the member is disposed within the stake pocket.

10. The apparatus of claim 9 wherein the first bore comprises:
a smooth bore portion having a smooth inner surface, wherein the smooth bore portion is configured to accommodate a vehicle accessory having a smooth outer surface; and
a threaded bore portion having a threaded inner surface, wherein the threaded bore portion is configured to accommodate a vehicle accessory having a threaded outer surface.

11. The apparatus of claim 10 wherein:
the first bore extends through the member between the first surface and the second surface;
the smooth bore portion extends from the first surface; and
the threaded bore portion extends from the second surface.

12. The apparatus of claim 9 wherein:
the member further comprises a third bore extending through the member;
the third bore is configured to accommodate a fastener for detachably connecting the vehicle accessory to the member when the vehicle accessory is disposed within the first bore; and
the first bore and the third bore intersect.

13. The apparatus of claim 9 wherein:
the member has a central axis;
the first bore extends along a central axis; and
the central axis of the member and the second central of the bore are parallel and offset from each other.

14. The apparatus of claim 9 wherein the vehicle accessory comprises at least one of:
a flagpole;
an antenna;
a whip;
an anchor bolt; and
a threaded bolt.

15. An apparatus comprising:
a member configured to be disposed within a stake pocket of a vehicle and facilitate attachment of a vehicle accessory to the vehicle, wherein the member comprises:
a first surface defining a first end of the member;
a second surface defining a second end of the member, wherein the member is configured such that the first surface and the second surface are located below an opening of the stake pocket when the member is disposed within the stake pocket;
a first bore extending through the member from the first surface, wherein the first bore is configured to accommodate the vehicle accessory; and
a second bore extending through the member, wherein the second bore is configured to accommodate a fastener for detachably connecting the vehicle accessory to the member when the vehicle accessory is disposed within the first bore, and wherein the first bore and the third bore intersect.

16. The apparatus of claim 15 wherein the member further comprises:
a third surface between the first surface and the second surface, wherein the third surface is configured to contact a surface of the vehicle when the member is disposed within the stake pocket; and
a third bore extending through the member from the third surface, wherein the third bore is configured to accommodate a fastener for detachably connecting the member to the surface of the vehicle when the member is disposed within the stake pocket.

17. The apparatus of claim 15 wherein the first bore comprises:
a smooth bore portion having a smooth inner surface, wherein the smooth bore portion is configured to accommodate a vehicle accessory having a smooth outer surface; and
a threaded bore portion having a threaded inner surface, wherein the threaded bore portion is configured to accommodate a vehicle accessory having a threaded outer surface.

18. The apparatus of claim 17 wherein:
the first bore extends through the member between the first surface and the second surface;
the smooth bore portion extends from the first surface; and
the threaded bore portion extends from the second surface.

19. The apparatus of claim 15 wherein:
the member has a central axis;
the first bore extends along a central axis; and
the central axis of the member and the second central of the bore are parallel and offset from each other.

20. The apparatus of claim 15 wherein the vehicle accessory comprises at least one of:
a flagpole;
an antenna;
a whip;
an anchor bolt; and
a threaded bolt.
